(19) United States
(12) Patent Application Publication
(10) Pub. No.: US 2019/0185132 A1
(43) Pub. Date: Jun. 20, 2019

(54) NOSE SECTION FOR AN AIRCRAFT

(71) Applicant: Airbus Operations SAS, Toulouse (FR)

(72) Inventors: Bernard GUERING, MONTRABE (FR); Romain DELAHAYE, COLOMIERS (FR)

(21) Appl. No.: 16/221,028

(22) Filed: Dec. 14, 2018

(30) Foreign Application Priority Data
Dec. 19, 2017 (FR) 1762513

(51) Int. Cl. B64C 1/14; B64C 1/06

(52) U.S. Cl. CPC B64C 1/1476; B64C 2001/0045; B64C 1/061

(57) ABSTRACT

A nose section of an aircraft comprising a centered flight deck, making it possible to offer a direct forward field of view towards the outside of the aircraft, the forward visibility of the pilot towards the outside taking priority, and an indirect lateral field of view afforded by image displays displaying images representing the lateral environment of the centered pilot and obtained from an image capturing device.

### CROSS-REFERENCES TO RELATED APPLICATIONS

This application claims the benefit of the French patent application No. 1762513 filed on Dec. 19, 2017, the entire disclosures of which are incorporated herein by way of reference.

### FIELD OF THE INVENTION

The present invention relates to the field of fuselage nose sections for aircraft notably intended for carrying passengers and/or freight.

### BACKGROUND OF THE INVENTION

Throughout the remainder of the description, “nose section” means the entire front part of the fuselage in which there is a flight deck the shape of which evolves at least in part from a flight deck rear bulkhead as far as a point of zero cross section corresponding to the front end of the fuselage. In the embodiments illustrated in FIGS. 1 to 5 and 10 to 12, the nose section has dimensions that decrease progressively from the flight deck rear bulkhead as far as the front end of the aircraft.

The presence of the flight deck in the nose section means that a large glazed surface needs to be provided in order to provide visibility to the outside. In most aircraft, the flight deck accommodates two pilots stationed one beside the other. One of them is referred to as a co-pilot but performs the same pilot role. It is therefore necessary to provide both pilots with the same visibility, and this necessitates a glazed area of great size.

Now, it is absolutely essential to maintain a determined pressure within the aircraft during flight, at altitudes at which the external pressure differs vastly from the pressure required by the individuals on board. It is also important to protect the pilot and co-pilot against bird strike and impacts from stones or other types of varied objects. It therefore follows that there are various stresses applied to the nose section of an aircraft which make its design complex in order to provide both strength, rigidity and robustness while at the same time allowing a certain degree of flexibility to absorb such impacts. Making openings in the fuselage to insert window panels increases the complexity thereof: the openings weaken the structure and the loads applied to the window panels are great.

Throughout the remainder of the description, the term window panel refers to a flight deck window panel. In most aircraft, like the one depicted in FIG. 1, there are a central window panel and a plurality of lateral window panels to provide the pilots and co-pilot with visibility from the flight deck to the outside. It is necessary to strengthen the structure around the periphery of the window panels using a special surround and stiffeners, the location and placement of which are designed to optimize their number and their mass. The design and manufacture of the region around the window panels is therefore complex given the constraints and stresses involved.

Patent application FR3000026 was filed on 21 Dec. 2012 by AIRBUS OPERATIONS SAS and proposes a nose section that has no glazed surface. Such an embodiment makes it possible to alleviate all the aforementioned disadvantages but offers the pilots no direct visibility.

It is an object of the present invention to propose a nose section that is somewhere between the current nose sections that are complex to produce, and the one disclosed in the aforementioned patent that eliminates all direct visibility.

### SUMMARY OF THE INVENTION

In order to do that, the present invention relates to a nose section of an aircraft comprising a centered flight deck, characterized in that it comprises at most three frontal window panels making it possible to offer a direct forward field of view C1 towards the outside of the aircraft, an indirect lateral field of view C2 beyond the field C1 being afforded by image display means displaying images representing the lateral environment of the centered pilot and obtained from image capture means.

Because there is now just a single part offering direct visibility, the manufacture of the nose section window panel region is simplified.

The nose section has at least one of the following optional features, considered in isolation or in combination.

The lateral field of view C2 is the one situated on each side of the forward field of view C1.

The lateral field of view C2 is continuous with the forward field of view C1.

The direct forward field of view C1 towards the outside of the aircraft is less than or equal to plus or minus 50 degrees in a horizontal plane with respect to a central vertical plane containing the central longitudinal axis X-X and at the point consisting of the intersection between the midline Y-Y of the pilot's view and the axis X-X.

It comprises a single frontal window panel making it possible to offer a forward field of view C1 of plus or minus 30 degrees.

It comprises a single frontal window panel making it possible to offer a forward field of view C1 of plus or minus 20 degrees.

The lateral field of view C2 is continuous with the frontal field of view C1 and extends at least out to plus or minus 100 degrees.

The upper edge of the single frontal window panel forms part of a frame of the nose section, and the lower edge of the frontal window panel forms part of a longitudinal stiffener of the nose section.

The geometric shape of the or of at least one of the window panels is approximately trapezoidal.

The lateral edges of the single frontal window panel meet and their joint is connected to a frame of the nose section.

It comprises a rectangular-shaped escape hatch in the upper part of the nose section.

The upper edge of the surround of the single frontal window panel forms part of a frame of the nose section and the lower edge of the escape hatch forms part of a frame of the nose section, and the frames are connected by a W-shaped structure, the inverted V of the W-shaped structure corresponding to the extension of the lateral edges of the surround of the single frontal window panel, and one of the ends of the beams on each side of the V being connected to the upper ends of the lateral edges of the single frontal window panel and the other end to the lower ends of the lateral edges of the hatch surround.

The present invention also relates to the aircraft comprising a nose section as described hereinabove.

### BRIEF DESCRIPTION OF THE DRAWINGS

Further objects, advantages and features of the invention will become apparent from reading the description of the invention, given by way of nonlimiting example, with reference to the attached drawings in which:

FIG. 1 depicts a perspective side view of an aircraft of known type to which the invention may be applied;

FIG. 2 depicts a three-quarters perspective view of a nose section according to the present invention, the forward field of view offered being depicted to the side of this view;

FIG. 3 depicts a three-quarters perspective view of a nose section according to an alternative to the embodiment depicted in FIG. 2, the forward field of view offered being depicted to the side of this view;

FIG. 4 depicts a three-quarters perspective view of a nose section according to an alternative to the embodiments depicted in FIGS. 2 and 3, the forward field of view offered being depicted to the side of this view;

FIG. 5 depicts a simplified face-on view of the nose section depicted in FIG. 4;

FIG. 6 depicts a simplified enlarged view of the front window panel region depicted in FIG. 5;

FIG. 7 depicts a simplified enlarged schematic perspective view of the front window panel region viewed from the point of view of the pilot of whom the face is partially depicted;

FIG. 8 depicts a simplified schematic side view of the inside of the flight deck for an embodiment comprising a single frontal window panel;

FIG. 9 depicts a simplified schematic perspective view from the rear of the inside of the flight deck for an embodiment comprising a single frontal window panel;

FIG. 10 depicts a simplified three-quarters perspective view of the structure of the nose section according to the embodiment comprising a single frontal window panel;

FIG. 11 depicts a simplified plan view, from above, of the structure of the nose section depicted in FIG. 10; and

FIG. 12 depicts a simplified side view of the structure of the nose section depicted in FIG. 10.

### DETAILED DESCRIPTION OF THE PREFERRED EMBODIMENTS

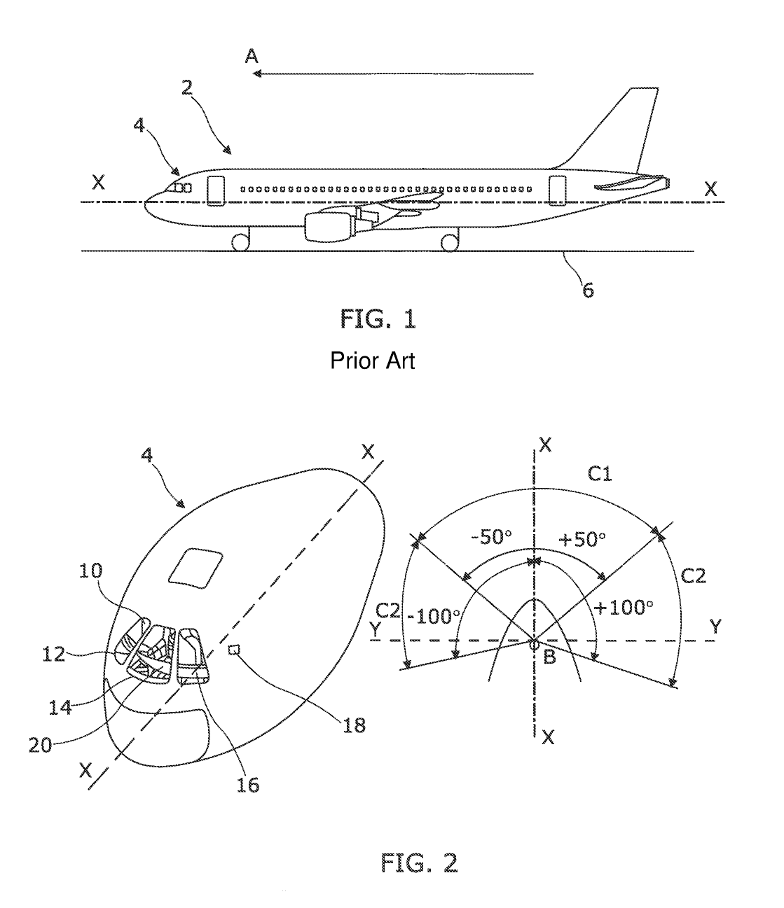

As depicted by an example of aircraft 2 of known type in FIG. 1, the present invention relates to a fuselage nose section 4 for an aircraft notably dedicated to transporting passengers and/or freight. The terms front and rear are considered in relation to the direction of travel of the aircraft in flight as indicated by the arrow A in FIG. 1. In the remainder of the description, the aircraft 2 is considered to rest on ground 6 defining a horizontal plane, any plane perpendicular to the ground therefore being vertical.

Evolutions in flight decks are leading towards aircraft controlled by a single pilot 8 transversely stationed in a central location. An aircraft is controlled by a single pilot 8 or by a pilot 8 assisted by an individual 10 who does not have a pilot role but simply acts as an assistant. In both instances, the pilot 8 is stationed in the vertical plane containing the central longitudinal axis X-X of the aircraft passing through the front end of the aircraft depicted in FIGS. 1 and 2, and the flight-control systems are arranged around the pilot, centered on him. In the case of an additional individual 10 who assists the pilot, that individual is offset from the pilot rearwards and to one of the sides of the pilot.

In the remainder of the description, whatever the configuration, a pilot 8 stationed transversely in the center of the cockpit will be referred to as a centered pilot.

The present invention proposes a nose section 4 provided with at least three frontal window panels 12, 14, 16 making it possible to offer a direct forward field of view C1 towards the outside as indicated by the double ended arrow in FIGS. 2, 3 and 4 that is less than or equal to plus or minus 50 degrees in a horizontal plane with respect to the central vertical plane containing the axis X-X and at the point B consisting of the intersection between the midline Y-Y of the view of the centered pilot 8 and the central longitudinal axis X-X, an indirect lateral field of view C2 being afforded by image display means displaying images representative of the lateral environment of the centered pilot and obtained from the image capture means. The midline Y-Y of the sight of the centered pilot 8 is determined by the front section designer: it corresponds for example to the line connecting the pupils of a pilot of median build. As pilot builds vary, reference is made, for example, to a median size, namely the size which is statistically most widespread. The lateral field of view C2 is understood to be the field of view situated on each side of the forward field of view C1. According to the embodiments illustrated in FIGS. 2 to 4, the lateral field of view C2 is continuous with the central field of view C1. For example, in the embodiment illustrated in FIG. 2, the lateral field of view C2 extends beyond the field C1 by plus or minus 50 degrees. In the present embodiment, the field of view extends at least out to plus or minus 100 degrees.

The field of view C1 can be duplicated, at least in part, by an indirect field of view in the same way as for the field C2, namely using display means. The pilot chiefly uses the display means that allow him to have not only a very clear view of the external environment, but also additional information overlaid on the means in question. The direct visibility allows the pilot in the flight phase to have certain view of traffic ahead of him and for the take-off and landing phases, which, as seen earlier, are phases sensitive to having direct visibility of the runway in order for example to spot unexpected obstacles. The direct visibility is also of great value in the event of system breakdown.

The image capture means and the display means that display these images may be of any known type and, for example, comprise at least one camera 18 (of which an example is depicted in FIGS. 2, 3 and 4) located outside the aircraft, in the case of the image capture means, and at least one screen 20 (of which an example is illustrated in FIG. 8), in the case of the means for displaying these images. The type, number and position of the camera or cameras allow the pilot to be offered greater visibility than the direct visibility offered by the lateral window panels in known aircraft. All the zones outside the aircraft may, for example, be reproduced on screen.

Other display means may be used: the images may, for example, be viewed through holograms or alternatively through a virtual reality helmet, etc. The term image is to be understood in a generic sense because it may just as well be an actual acquired image, as a reproduced virtual image, as a combination of an actual image enriched with virtual images or information. The image capture means in the case of virtual images are once again to be understood in a generic sense namely as an image reconstruction means. The images are, of course, to be understood to form an animated assembly so as to reproduce the actual environment.

The new design of nose section proposed is based on the fact that the forward visibility towards the outside takes priority: it is important in the phase of cruising flight to have a view of the traffic ahead and, for the take-off and landing phases which are the phases of the flight sensitive to having direct visibility of the runway in order, for example, to spot unexpected obstacles. Lateral visibility on the ground, just as in flight, is of secondary priority and can therefore be performed indirectly using suitable systems. The present design allows the structure of the nose section to be adapted to suit the actual requirements and optimize production thereof.

According to the embodiment depicted in FIG. 2, the nose section comprises three frontal window panels 12, 14, 16, making it possible to offer a forward field of view C1 towards the outside of the aircraft of plus or minus 50 degrees in a horizontal plane with respect to the central longitudinal axis X-X.

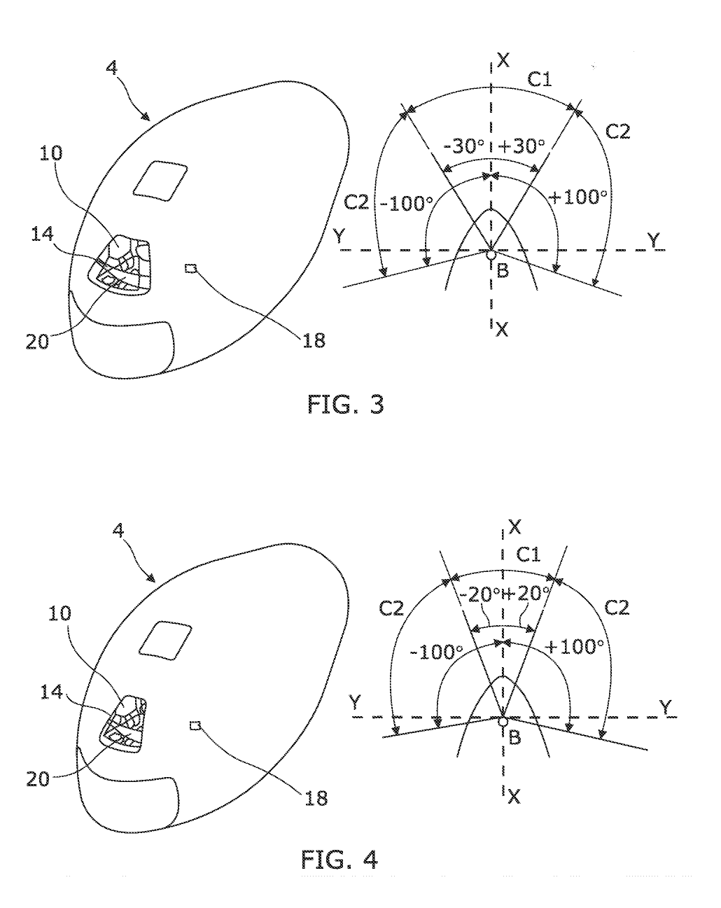

According to the embodiment depicted in FIG. 3, the nose section comprises a single frontal window panel 14 making it possible to offer a forward field of view C1 towards the outside of the aircraft of plus or minus 30 degrees or, according to another embodiment depicted in FIG. 4, of plus or minus 20 degrees in a horizontal plane with respect to the central longitudinal axis X-X.

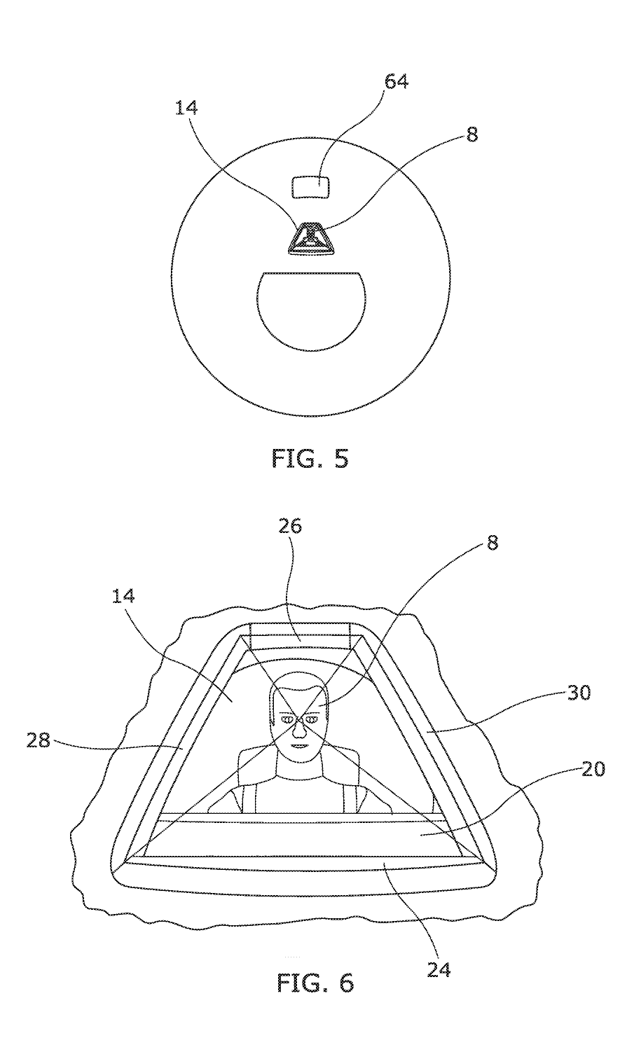

FIG. 5 depicts the aircraft viewed face-on and shows the significant reduction in glazed area which is limited to the direct forward visibility alone.

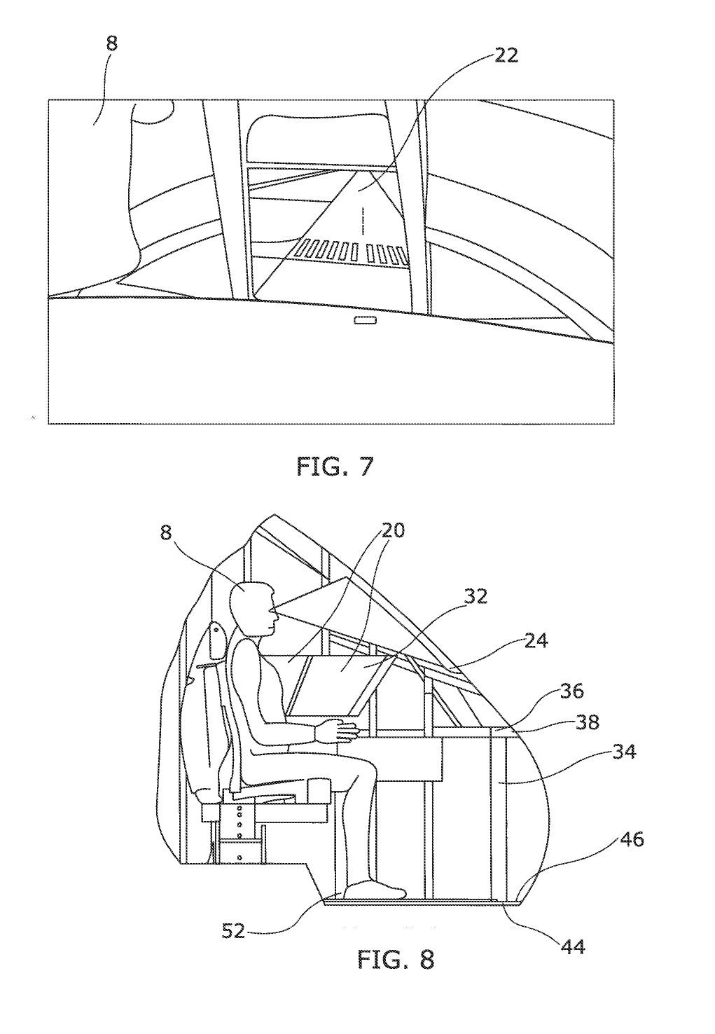

According to the embodiments illustrated in FIGS. 2 to 5, the height of the window panel or panels 12, 14, 16 is equivalent to that of current window panels. The rule applied is that the pilot must be able to see the take-off runway 22 or the landing runway during the respective take-off and landing phases, as shown in FIG. 7. The direct lateral field of view is reduced by comparison with what currently exists, the portion removed being replaced by an indirect field of view using display means; the direct forward field of view is itself maintained.

In the embodiment illustrated and clearly visible in FIG. 6, the shape of each of the window panels is overall that of an isosceles trapezium, namely that, more specifically, the curved horizontal lower 24 and upper 26 edges of the surround of the single window panel 14 are joined by curved lateral edges 28, 30 of the surround which diverge from one another in the downwards direction in an identical manner.

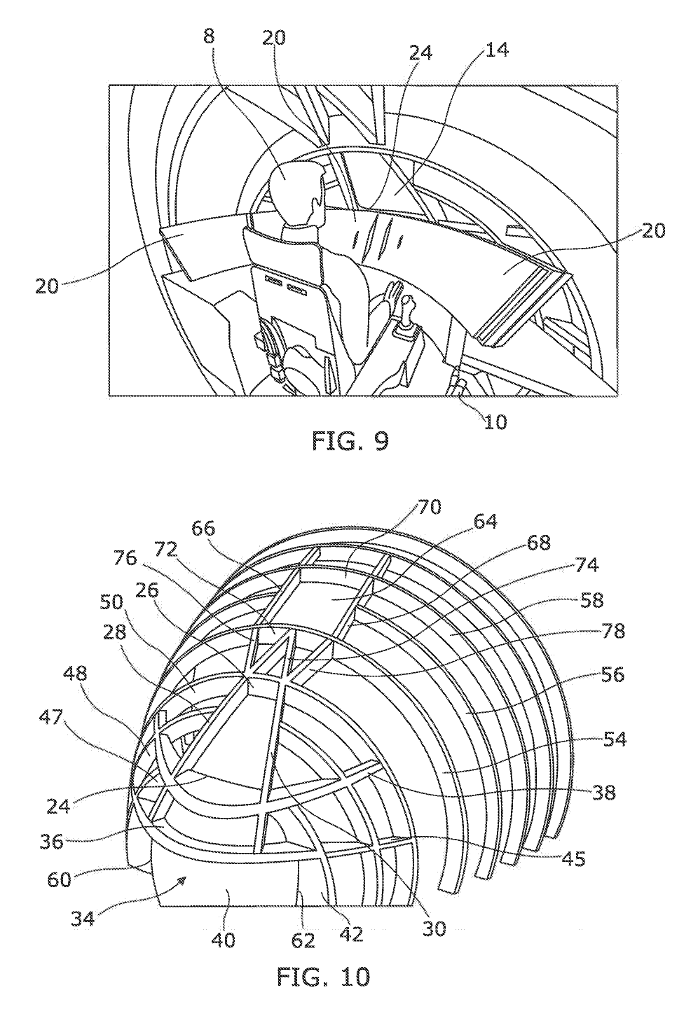

In the embodiment illustrated and best visible in FIGS. 8 and 9, the lower edge 24 of the window panel surround is, horizontally, approximately level with the upper edge of the screen 20 opposite the frontal window panel 14; the horizontal lower edge 24 of the surround of the window panels cannot extend vertically downwards beyond the upper edge 36 of a pressure-tight end wall 34. The horizontal lower edge 24 forms part of a longitudinal stiffener 38 of the nose section, referred to as the upper stiffener.

The pressure-tight end wall 34 in the embodiment illustrated has a part 40 of semicylindrical shape making it possible to offer additional volume so that the pilot can be moved forwards, freeing up space for the cabin. However, it could have any other type of shape. The pressure-tight end wall comprises the semicylindrical central part 40 the generatrices of which are vertical, and a planar peripheral part 42 extending partially around the central part 40. The horizontal upper and lower edges 36, 44 of the central part 40 are positioned level with the intermediate 45 and lower 46 longitudinal stiffeners fixed to part of the frames 47, 48, 50 of the nose section. The lower edge 44 of the central part 40 adjoins the front end edge of the end wall 34 to which it is fixed (clearly visible in FIG. 8).

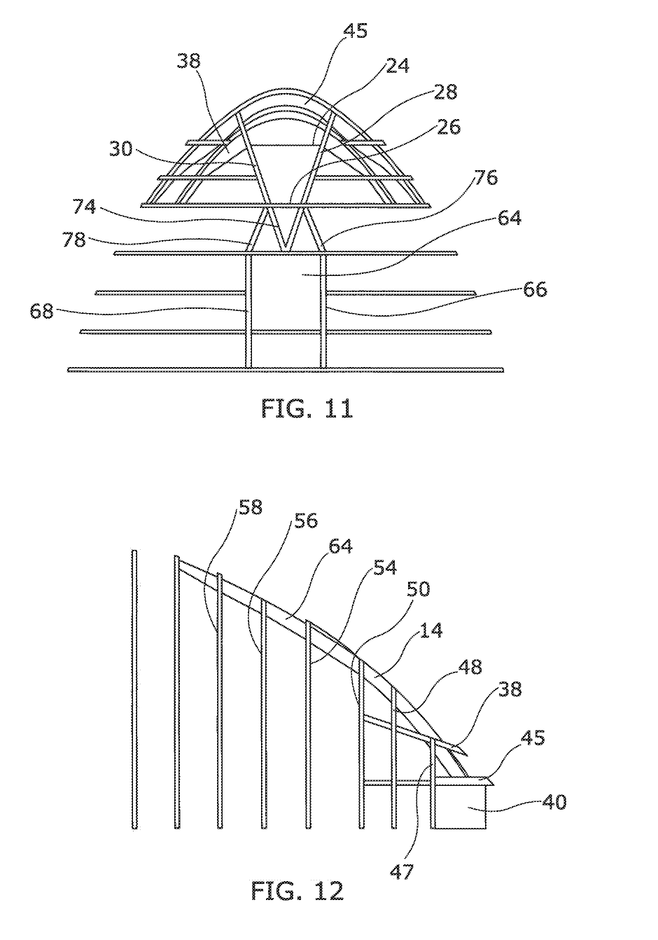

As shown in the embodiment illustrated in FIGS. 10 to 12, the front part of the aircraft comprises circumferential frames 47, 48, 50, 54, 56, 58. The forwardmost frame 47 is referred to as the forwardmost main frame. As illustrated in FIG. 10, the pressure-tight end-wall 34 is positioned at the level of the forwardmost main frame 47: the forwardmost main frame 47 lies in the plane of the lateral edges 60, 62 of the central part 40 of the pressure-tight end-wall. The peripheral part 42 of the pressure-tight end-wall extending from the central part 40 as far as the fuselage partially forms the forwardmost frame 47 which therefore finds itself reinforced by comparison with the other frames of smaller dimensions. The peripheral part 42 extends over part of its circumference (namely at least short of the upper horizontal edge 36 of the central part 40) the forwardmost frame 47 as far as the central part 40.

In the embodiment illustrated, the peripheral part 42 is extended above the pressure-tight end-wall to close the frame 47 and give the peripheral part an annular overall shape by forming a single entity with the frame 47. In that case, the intermediate stiffener 45 is interrupted at the pressure-tight end-wall and fixed thereto on each side.

The horizontal upper edge 26 of the surround of the frontal window panel joins the lateral edges 28, 30 of this surround before these edges meet, the lateral edges as seen earlier being inclined with respect to one another in the approximate shape of an isosceles triangle, approximately taking into consideration the double curvature of the edges. The joining point of the lateral edges 28, 30 is connected to a reinforced frame 54 referred to as the hatch bottom frame. According to the embodiment illustrated, the horizontal upper edge 26 of the surround of the frontal window panel is level with a frame 50 referred to as the window panel top frame, the continuity of which it thus affords. It lies at a level that is vertically above the line of sight of the majority of centered pilots, the build of which can vary, namely for example, for future generations, between 1.48 and 2.02 meters.

As depicted in FIGS. 6 and 7, the line of sight of the centered pilot is closer to the upper edge 26 than to a lower edge 24 of the frontal window panel 14 and, in the example illustrated, falls in the upper half thereof.

According to the embodiment illustrated, the upper part of the nose section comprises an escape hatch 64. The hatch 64 in the example illustrated is situated in line with the pilot's position on the flight deck. The hatch 64 constitutes a second opening in the fuselage, weakening the structure.

In the embodiment illustrated, the hatch 64 is rectangular in shape and comprises two lateral edges 66, 68 parallel to one another and two, upper and lower, edges 70, 72, parallel to one another.

The upper and lower edges 70, 72 of the hatch 64 are incorporated into the frames 58, 54 in order to ensure continuity thereof.

The window-top frame 50 and the hatch-bottom frame 54 are connected by a W-shaped structure that allows load to be diverted towards the lateral edges of the hatch 64. The W-shaped structure is made up of an inverted V 74 and of two beams 76, 78 on each side of the inverted V. The inverted V 74 is made up of the extension of the lateral edges 28, 30 of the frontal window panel by the beams 76, 78 which meet at the hatch-bottom frame 54, thus forming the V. On each side of the inverted V 74, one of the ends of the two beams 76, 78 is connected to the ends of the lateral edges 28, 30 of the frontal window panel, the other end being connected to the ends of the lateral edges 66, 68 of the hatches.

As shown in FIGS. 8 to 10, the trapezoidal overall shape of the frontal window panel 14 and the positioning of all of the structural elements required for the reinforcements necessitated by the opening made for the frontal window panel and the rectangular opening for the hatch 64 has been optimized to achieve a simplified structure comprising two longitudinal stiffeners 38, 45, circumferential frames 47 to 58 and a W-shaped structure for distributing the load between the frontal window panel and the hatch.

Thus, the glazed surface is very significantly reduced in comparison with that of existing aircraft, thereby reducing the mass and the cost of the nose section. Because the nose section structure has been optimized, the nose section has a shape with dual aerodynamic curvature, leading to reduced drag.

Furthermore, it is necessary to offer the pilots a good position between visibility of the outside and internal ergonomics, namely the learning of the flight deck instruments and control systems. In the embodiment proposed using a partially cylindrical shape of pressure-tight end-wall, the pilot's position can be moved forwards by comparison with his usual position, thereby making it possible to reduce the glazed surface still further while at the same time, owing to the centered position of the pilot, integrating the control systems and equipment with respect thereto.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nose section of an aircraft comprising:
a centered flight deck for a pilot,
at most, three frontal window panels making it possible to offer a direct forward field of view towards an outside of the aircraft,
an indirect lateral field of view beyond the forward field of view being afforded by an image display displaying images representing a lateral environment of the centered pilot and obtained from at least one image capturing device.

2. A nose section according to claim 1, wherein the lateral field of view is situated on each side of the forward field of view.

3. A nose section according to claim 1, wherein the lateral field of view is continuous with the forward field of view.

4. The nose section according to claim 1, wherein the direct forward field of view towards the outside of the aircraft is less than or equal to plus or minus 50 degrees in a horizontal plane with respect to a central vertical plane containing a central longitudinal axis of the aircraft and at a point comprising an intersection between a vertical midline of a view of the pilot and a lateral axis of the aircraft.

5. The nose section according to claim 1, further comprising a single frontal window panel making it possible to offer a forward field of view of plus or minus 30 degrees.

6. The nose section according to claim 1, further comprising a single frontal window panel making it possible to offer a forward field of view of plus or minus 20 degrees.

7. The nose section according to claim 1, wherein the lateral field of view extends at least out to plus or minus 100 degrees.

8. The nose section according to claim 5, wherein the lateral field of view extends at least out to plus or minus 100 degrees, and wherein an upper edge of the single frontal window panel forms part of a frame of the nose section, and a lower edge of the frontal window panel forms part of a longitudinal stiffener of the nose section.

9. The nose section according to claim 1, wherein a geometric shape of at least one window panel is approximately trapezoidal.

10. The nose section according to claim 5, further comprising a single frontal window panel making it possible to offer a forward field of view of plus or minus 20 degrees, and wherein lateral edges of the single frontal window panel join at a point, and the joining point is connected to a frame of the nose section.

11. The nose section for an aircraft according to claim 1, comprising a rectangular-shaped escape hatch in an upper part of the nose section.

12. The nose section for an aircraft according to claim 10, wherein an upper edge of the surround of the single frontal window panel forms part of a frame of the nose section and wherein a lower edge of the escape hatch forms part of a frame of the nose section, and wherein the frames are connected by a W-shaped structure, an inverted V of the W-shaped structure corresponding to an extension of lateral edges of the surround of the single frontal window panel, and an end of beams on each side of the V being connected to upper ends of lateral edges of the single frontal window panel and an other end to lower ends of the lateral edges of the hatch surround.

13. An aircraft comprising a nose section according to claim 1.
